(19) United States
(12) Patent Application Publication
(10) Pub. No.: US 2015/0222561 A1
(43) Pub. Date: Aug. 6, 2015

(54) BANDWIDTH CONTROL APPARATUS

(71) Applicant: HITACHI, LTD., Tokyo (JP)

(72) Inventors: Michitaka OKUNO, Tokyo (JP); Masashi YANO, Tokyo (JP); Nodoka MIMURA, Tokyo (JP); Yuta MUTO, Tokyo (JP); Daisuke ISHII, Tokyo (JP)

(21) Appl. No.: 14/530,847

(22) Filed: Nov. 3, 2014

(30) Foreign Application Priority Data
Feb. 6, 2014 (JP) 2014-020916

(51) Int. Cl. H04L 12/873; H04L 29/06; H04L 12/865

(52) U.S. Cl. CPC H04L 47/522; H04L 47/6275; H04L 69/22; H04L 47/60

(57) ABSTRACT

A scale-out of a gateway server is realized according to a rapid increase in communication volume, without incurring system down. A high-quality communication is provided to priority users even during scaling out the gateway server. A high-quality communication is continuously provided to priority users without incurring the system down even if the scale-out/in of the gateway server is repeated. A bandwidth control apparatus transmits packets to plural virtual nodes equipped in a server device, reads the packets from any high priority queue and any low priority queue which are associated with the subject apparatus, and limits the packets to an upper limit bandwidth determined for each of the virtual nodes, and changes association of the high priority queues and the low priority queues with the virtual node bandwidth limiters according to an instruction from the control server for determining the scale-out/in of the virtual node.

### CROSS-REFERENCE TO RELATED APPLICATION

This is application claims the priority from Japanese Patent Application No. 2014-020916 filed on Feb. 6, 2014, the content of which is incorporated herein by reference in its entirety.

### BACKGROUND OF THE INVENTION

1. Field of the Invention

The present invention relates to a communication system, and more particularly to a bandwidth control apparatus.

2. Description of the Related Art

In recent years, smartphones and tablet devices have spread rapidly, as a result of which mobile traffic has been increasing rapidly. Communication carriers are required to predict the traffic volume in advance, and prepare network devices required as communication nodes (MME (mobility management entity), S-GW (serving gateway), P-GW (public data network gateway), etc.) of a mobile core network.

Normally, those network devices are formed of dedicated hardware, and suffer from such problems that a procurement period is as long as several month units, the flexibility of designs, setting, and operability is low, and equipment costs are high. In response to those problems, on behalf of the dedicated hardware, there has been propounded a concept of a network function virtualization (NFV) intended to solve the problems by introducing a virtualization technology in general-purpose servers, by ETSI Industry Specification Group in November 2012. With the concept of NFV, a communication node (MME, S-GW, P-GW, etc.) of a mobile core network is realized in a virtual machine of a general-purpose server, and a communication node that conducts a relay process can be automatically scaled out or in according to a communication variation.

On the other hand, when the node is automatically scaled out, at least a time of a few seconds to a few minutes is required at minimum to complete the scale-out. If a lot of communication is continuously received before the scale-out is completed, there is a possibility that OS or firmware that runs the virtual machine becomes an overload situation, and the system would be down.

In addition, in the communication of a user using this system, if the communication of other users increases in large quantities, a large amount of packet loss occurs until the scale-out of the communication node has been completed. This is a problem for the user who desires high quality communication even paying an additional fee.

In the viewpoint that servers in the system are scaled out according to the communication variation, JP-A-2012-208781 discloses as a problem that “there are provided an information processing system, an information processing device, a scaling method, a program, and a recording medium for realizing an automatic scaling mechanism to increase or decrease a server scale in response to changes in demand in cloud computing environment”. JP-A-2012-208781 also discloses as the solution that “this information processing system includes a processing server group having plural processing servers, an alternate server to respond with an alternative to the processing server group, and a load balancer that distributes traffic to a processing server group, and transfers the traffic to the alternate server when the processing server group becomes in an overload state. This information processing system further prepares a processing server of the processing server group which calculates a target scale of the processing server group according to a transfer amount to be transferred to the processing server group by the load balancer and a transfer amount to be transferred to the alternate server, for increasing the present scale of the processing server group to the target scale.”

### SUMMARY OF THE INVENTION

In the technique disclosed in JP-A-2012-208781, when a web server becomes overload, a new connection request is transferred to the alternate server during which the web server is scaled out, to thereby protect the web server from being down by excessive connection. However, when the technology of JP-A-2012-208781 is applied to a server that relays a general mobile communication, in a situation where the user has left the text references simultaneously, and performs a large amount of data communication such as video reference, because of no new connection request for the relay server, the transfer to the alternate server is not performed. As a result, because a load of the relay server increases, an overload state of the relay server cannot be avoided, and the system down may be caused until the scale-out has been completed. In other words, it is problematic to realize the scale-out of the gateway server without causing the system down according to a rapid increase of the communication volume.

Also, it is problematic to continuously provide high-quality communication to priority users during scaling out of the gateway server.

Also, it is problematic to continuously provide high-quality communication to priority users without incurring the system down even if the gateway server is repetitively scaled out or in.

The present invention includes plural means for solving at least one of the above problems, and one example of those means provides a bandwidth control apparatus that transmits packets to a plurality of virtual nodes equipped in a server device, the apparatus including: a controller that controls the bandwidth control apparatus; and a buffer unit that controls queues which hold the packets, in which the buffer unit includes: a plurality of high priority queues that holds the packets of high priority, and guarantees a packet transmission amount in a given guaranteed bandwidth; a plurality of low priority queues that holds packets of low priority; and a virtual node bandwidth limiter that is disposed for each of the virtual nodes, reads the packets from any high priority queue and any low priority queue which are associated with the virtual node bandwidth limiter, and limits the packets to an upper limit bandwidth determined for each of the virtual nodes, in which the buffer unit changes association of the high priority queues and the low priority queues with the virtual node bandwidth limiter according to an instruction from the controller that is instructed from a control server that determines scale out or in of the virtual nodes.

The present invention obtains at least any advantages described below. According to the present invention, even in an overload status, because a communication inflow into the respective nodes is controlled, the system down (down of node group) can be avoided. Also, in communication of priority users, a high-quality communication can be continuously provided with the avoidance of a packet loss even in an overload status. Also, the high quality communication can be continuously provided for the priority users without incurring the system down even if scale out or in of the nodes is repeated.

### BRIEF DESCRIPTION OF THE DRAWINGS

FIG. 1 is a diagram illustrating a configuration example of a mobile core system;

FIG. 2 is a diagram illustrating a configuration example of a bandwidth control apparatus;

FIG. 3 is a diagram illustrating a configuration example of a buffer management table;

FIG. 4 is an exemplary flowchart illustrating the operation of the bandwidth control apparatus;

FIG. 5 is a diagram illustrating a configuration example (three-hierarchy shaping) of the bandwidth control apparatus;

FIG. 6 is an exemplary sequence diagram of processing in a normal state and a scale-out setting state of the system;

FIG. 7 is an exemplary flowchart of setting the bandwidth control apparatus;

FIG. 8 is a diagram illustrating a scale-out compatible example in a scale-out/in compatible buffer unit in the bandwidth control apparatus;

FIG. 9 is a diagram illustrating a scale-out compatible example of a distribution table; and

FIG. 10 is a diagram illustrating a processing sequence example in a scale-in setting state of the system.

### DETAILED DESCRIPTION OF THE INVENTION

Hereinafter, embodiments of the present invention will be described with reference to the accompanying drawings. In the respective drawings, identical symbols denote identical or corresponding parts. For convenience of the description, subscripts may be added to symbols for distinction.

In this embodiment, a description will be given of a method of avoiding system down by introducing a bandwidth control apparatus of this embodiment into a mobile core network having a system that automatically scales out or in communication nodes that relay communication according to a communication variation, and a method of providing a high-quality communication to priority users.

### Configuration of Overall System

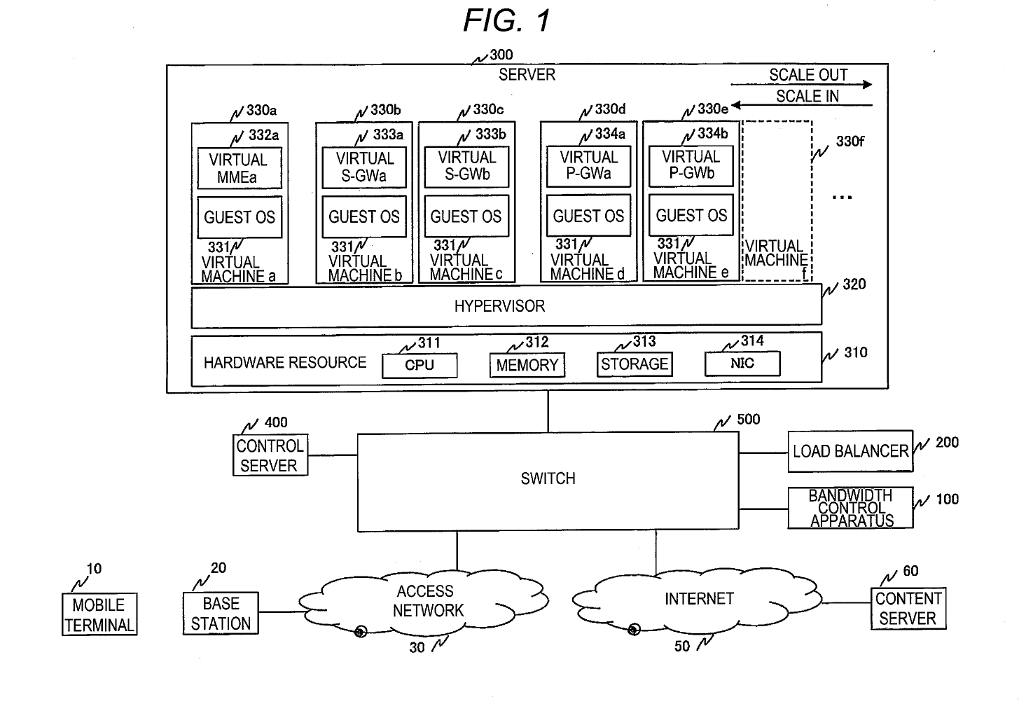

FIG. 1 illustrates a configuration example of a mobile core system according to an embodiment of the present invention. A mobile core system according to this embodiment is arranged at a position corresponding to a mobile core network between an Internet 50 connected with a content server 60 that is located in a data center, and an access network 30 connected with a base station 20 with which a mobile terminal 10 of a user communicates. The mobile core system is configured to connect a server 300 for operating communication nodes that relay mobile communication as virtual nodes on virtual machines 330, a load balancer 200 for distributing mobile communication to appropriate virtual nodes, a bandwidth control apparatus 100, and a control server 400 that controls the mobile core system, through a switch 500.

In FIG. 1, the load balancer 200 and the bandwidth control apparatus 100 are arranged in a one-arm configuration for the networks (Internet 50, access network 30), and the server 300. Alternatively, the load balancer 200 and the bandwidth control apparatus 100 may be arranged in an in-line configuration installed between the networks (Internet 50, access network 30) and the server 300.

### Server

The server 300 is physically one or more physical servers, and configured by plural physical servers with the exception of a minimum scale system. The server 300 includes a hardware resource 310 including a CPU 311, a memory 312, a storage 313, and an NIC (network interface card) 314 of the physical server 300. The server 300 also includes a hypervisor 320 of virtualization software that operates on the hardware resource 310, which operates the virtual machines 330 each having an OS such as Linux as a guest OS 331.

Also, as the virtual nodes on the virtual machines 330 that operates in the server 300, in the case of an LTE (long term evolution), an MME that is a base station control device, and an S-GW and P-GW which relay user data are allocated as a virtual MME, a virtual S-GW, and a virtual P-GW, respectively. As the numbers of the virtual MME, the virtual S-GW, and the virtual P-GW, the number designated directly by an operator, the number of available users notified from the operator, the total number of sessions, or the number determined by the control server 400 on the basis of the number of throughput requests per session is instructed the server 300, and prepared as an initial state. FIG. 1 illustrates a state in which the virtual machines 330 operate virtual MME 332a, virtual S-GWa 333a, virtual S-GWb 333b, and virtual P-GWa 334a, virtual P-GWb 334b as virtual nodes of the LTE.

In FIG. 1, for simplification of the description, the server 300, the load balancer 200, and the bandwidth control apparatus 100 of this embodiment are provided one by one. Alternatively, the plural servers 300, the plural load balancers 200, and the bandwidth control apparatuses 100 may be provided. Also, the load balancer 200 and the bandwidth control apparatus 100 may be integrated together.

### Load Balancer

The load balancer 200 is used to distribute a load between plural virtual nodes having the same function, for example, to distribute a load between the virtual S-GWa 333a and the virtual

S-GWb 333b, and to distribute a load between the virtual P-GWa 334a and the virtual P-GWb 334b. In FIG. 1, for convenience, the virtual S-GWs and the virtual P-GWs are illustrated two by two. However, in the actual operation, the load distribution is conducted on the virtual S-GWs 333 and the virtual P-GWs 334 of several tens to several hundreds, and in some cases, in excess of several thousands.

### Configuration of Bandwidth Control Apparatus

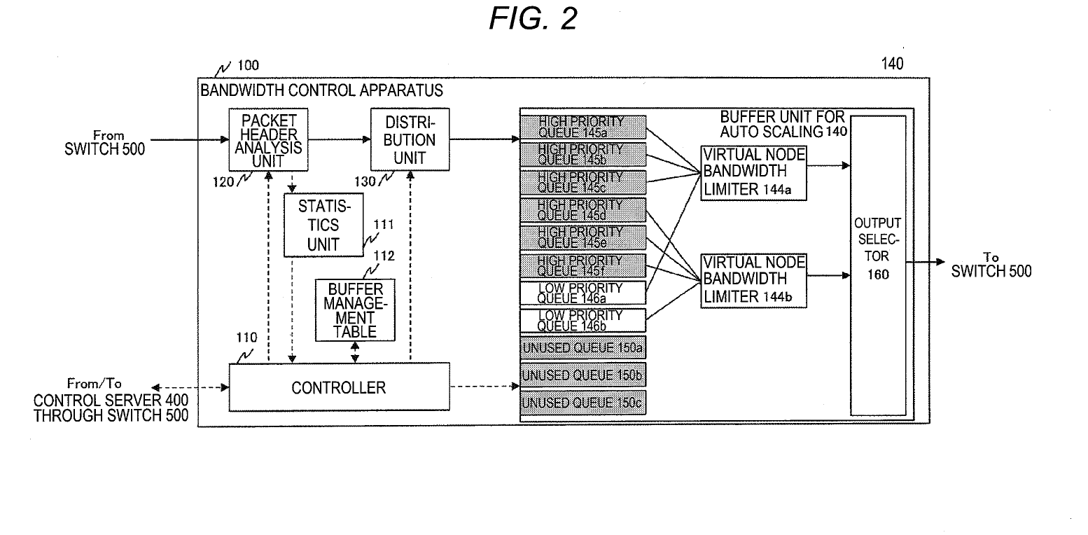

As illustrated in FIG. 2, the bandwidth control apparatus 100 includes a controller 110 that communicates with the external control server 400, and controls the interior of the bandwidth control apparatus 100, a statistics unit 111 that measures a specified number of communication packets such as the number of passing packets, a buffer management table 112 for managing a buffer for holding the packets, a packet header analysis unit 120 that analyzes a header of each received packet, specifies No. (number) of the virtual node to be processed with the use of the same distribution logic as that of the load balancer 200, and specifies a queue No. (number) according to a user to which the packets belong, and the communication type, a distribution unit 130 that distributes the packets on the basis of the virtual node No. (number), and the queue No. (number), and a buffer unit for auto scaling 140.

The buffer unit for auto scaling 140 includes high priority queues 145 that realize the packet transmission subjected to bandwidth guarantee, low priority queues 146 for packet transmission of best effort, unused queues 150 unavailable if there is no allocation request from the control server 400, a virtual node bandwidth limiter 144 that conducts bandwidth limit for each of the virtual nodes, and an output selector 160 that selects and outputs one of the packets within the buffer unit for auto scaling 140 (a buffer management table of the bandwidth control apparatus).

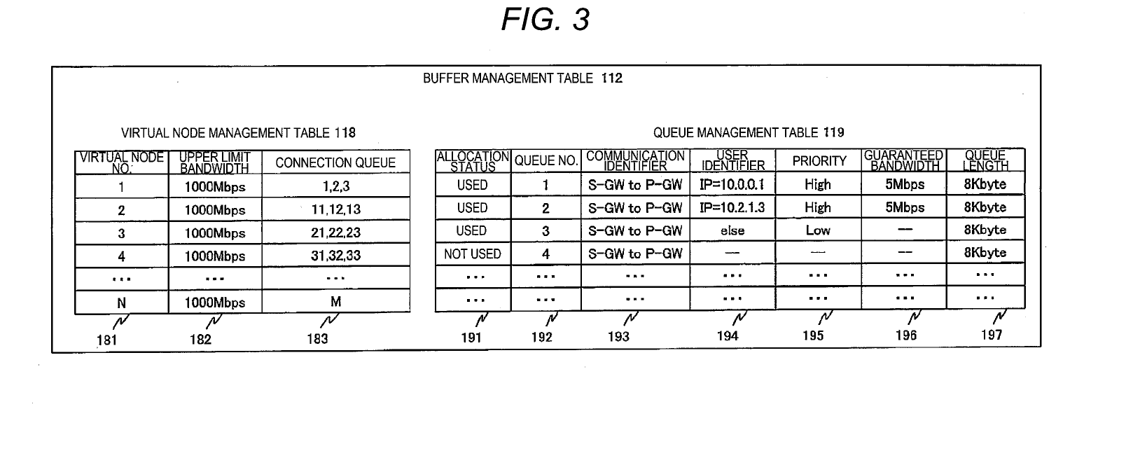

Also, an operator sets bandwidths to be guaranteed in a queue management table 119 of the butter management table 112 in the bandwidth control apparatus 100 illustrated in FIG. 3, for the users having a contract for high priority communication. Specifically, the control server 400 allocates one of the unused queues 150 as the high priority queue 145 for the appropriate user, records an allocation status as allocated in an allocation status field 191, records an allocated queue No. (number) in a queue No. (number) field 192, records an identifier for distinguishing communication by a protocol or a transmit/receive IP address in a communication identifier field 193, records an identifier such as an IP address that distinguishes the appropriate user in a user identifier field 194, records the priority as high in a priority field 195, records the guarantee bandwidth in a guarantee bandwidth field 196, and records a queue length in a queue length field 197, respectively.

Also, the control server 400 determines an upper limit bandwidth for each of the virtual nodes, and records the upper limit bandwidth in a virtual node management table 118 of the buffer management table 112 in the bandwidth control apparatus 100 illustrated in FIG. 3. Specifically, the control server 400 records No. (number) allocated to the virtual node in a virtual node No. (number) field 181, and records an upper limit bandwidth of the virtual node in an upper limit bandwidth field 182. Further, the control server 400 records No. (number) of the high priority queue 145 and No. (number) of the low priority queue 146 corresponding to the user to be processed in the appropriate virtual node in a connection queue field 183. The upper limit bandwidth represents an upper limit of a packet transmission amount of the virtual node. Also, the connection queue field 183 is disposed within the virtual node management table 118 in this example. Alternatively, the connection queue field 183 may be disposed independently from the virtual node management table 118, or may be provided as a field for recording information on the virtual node No. to be connected in the queue management table 119.

In the virtual node that performs data transfer processing such as the virtual P-GW 334 or the virtual S-GW 333, the usage of the upper limit bandwidth field 182 for designating the upper limit bandwidth is effective. However, in the virtual node that conducts the connection processing such as the virtual MME 332, it is preferable to use the upper limit bandwidth field 182 for designating an upper limit of the transaction amount. In this example, the transaction amount indicates how many times plural series of packet exchanges are conducted between the mobile terminal 10 and the virtual MME 332 when connecting the mobile terminal 10 to the mobile communication network. It is desirable to extract only the packets indicative of a first connection request from the mobile terminal 10, and use a total number of packets (the number of packets per given time such as 1 second).

The value to be recorded in the upper limit bandwidth field 182 is determined by various methods. As one example, there is a method of calculating a ratio of an input bandwidth to the individual virtual P-GW 334 to an output bandwidth from the same virtual P-GW 334 measured in the bandwidth control apparatus 100, and using the value when the ratio is 1.0 as the upper limit bandwidth. As another example, there is a method of inputting, in another system different from this system, a dummy traffic simulating a mobile network to the appropriate virtual P-GW 334, calculating a ratio of the input bandwidth to the same virtual P-GW 334 to an output bandwidth from the virtual P-GW 334, and using the value when the ratio is 1.0 as the upper limit bandwidth. In the case of the virtual MME 332, there is a method of continuously inputting only the packets indicative of the connection request, and using a maximum case (the number of connection request packets to be processed per given time such as 1 second) in a range where reply packets to the input packets can be normally generated as the upper limit bandwidth (upper limit transaction number).

Also, the value recorded in the upper limit bandwidth field 182 may be periodically changed after the value has been recorded once. This is because the length and the rate of the types of the packets which reach the virtual P-GW 334, the virtual S-GW 333, and the virtual MME 332 change momentarily, the appropriate upper limit bandwidth is reset. It is not desirable to change the length and the rate of the types in a very short period such as every hour or every several hours because the system may become unstable. If the length and the rate of the types periodically change, it is desirable to change the length and the rate of the types in a period of some length such as every two days, every several days, every two weeks, or every several weeks.

In the example of FIG. 3, the virtual node 1 connects a queue 1, a queue 2, and a queue 3 where the upper limit bandwidth is 1000 Mbps, and a communication identifier is a communication from S-GW to P-GW. The queue 1 and the queue 2 are high priority queues 145 where the guaranteed bandwidth is 5 Mbps, and have IP address IP=10.0.0.1 and IP=10.2.1.3 as the user identifiers, and a queue 3 is the low priority queue 146 that is not subjected to the bandwidth guarantee, and designates the IP address other than the high priority queues 145.

The control server 400 may be an application that operates on the virtual machines 330 which operate in the server 300. Likewise, the load balancer 200 is illustrated as another device different from the server 300, but the load balancer 200 may be an application that operates on the virtual machines 330 which operate in the server 300. Likewise, the bandwidth control apparatus 100 is illustrated as another device different from the server 300, but may be an application that operates on the virtual machines 300 which operate in the server 300.

The load balancer 200 and the bandwidth control apparatus 100 are portions highest in load through which all of the packets pass on the system. For that reason, an excessive load is applied even to the virtual machines 330 in an overload state, and the guest OS 331 on which an application that executes functions of the load balancer 200 and the bandwidth control apparatus 100 runs, and firmware of the guest OS 331 causes malfunction. As a result, the functions described in this embodiment could not be realized. For that reason, it is desirable that the load balancer 200 and the bandwidth control apparatus 100 are implemented as another dedicated hardware or server different from the server 300.

For example, in a mode where the bandwidth control apparatus 100 is implemented as the server, the server includes a CPU, a memory, and a storage. For example, the controller 110, the statistics unit 111, the packet header analysis unit 120, the distribution unit 130, the virtual node bandwidth limiter 144, and the output selector 160 read software programs for providing those functions from the memory or the storage, and the CPU executes those functions to realize those units. Also, the buffer management table 112, the high priority queues 145, the low priority queues 146, and the unused queues 150 can be realized by the memory or the storage.

### Operation of Overall System

First, operation of the overall system including the bandwidth control apparatus 100 in a normal state will be described. The communication from the mobile terminal 10 first establishes a communication path (tunnel, bearer) between the virtual S-GW, the virtual P-GW, and the Internet through the virtual MME. However, for simplification of the description, it is assumed that the establishment of the above communication path is completed.

In this embodiment, the user of the mobile core network finally downloads data (screen for browsing homepage, mails, or moving images) while accessing to the content server 60 such as a data center that holds desired information with the use of the mobile terminal 10. An access from the mobile terminal 10 passes through the access network 30 via the nearest base station 20, and is transferred to the load balancer 200 through the switch 500.

The load balancer 200 inspects header information on the packets from the mobile terminal 10, selects a designated one from the virtual S-GWs 333 that relays mobile communication, and allocates an identifier such as a VLAN tag for indicating the appropriate virtual S-GW 333 to the packet, or replaces a destination IP address of the packet. Thereafter, the load balancer 200 transfers the identifier to the bandwidth control apparatus 100.

The bandwidth control apparatus 100 buffers the packet according to a procedure to be described later, and thereafter transfers the packets toward the appropriate virtual S-GW 333 according to the designated bandwidth.

The virtual S-GW 333 encapsulates the received packets, and transmits the encapsulated packets to the switch 500. The switch 500 transfers the packets received from the virtual S-GW 333 to the load balancer 200.

The load balancer 200 inspects header information on the received packets, selects a designated one from the virtual P-GWs 334 that relays the mobile communication, and allocates an identifier such as a VLAN tag for indicating the appropriate virtual P-GW 334 to the packet, or replaces a destination IP address of the packet. Thereafter, the load balancer 200 transfers the identifier to the bandwidth control apparatus 100.

The bandwidth control apparatus 100 buffers the packets according to a procedure to be described later, and thereafter transfers the packets toward the appropriate virtual P-GW 334 according to the designated bandwidth.

The virtual P-GW 334 decapsulates the received packets, and transmits the packets to the switch 500. The switch 500 transmits the packets received from the virtual P-GW 334 to the Internet 50.

The packets arrive at the content server 60 such as the designated data center from the mobile terminal 10 through the Internet 50, and the content server 60 returns the required data as packets to the mobile terminal 10 according to the contents of payloads of the packets.

The packets from the content server 60 arrive at the mobile terminal 10 through a path opposite to an access to the content server 60 from the mobile terminal 10 described above. That is, the packets from the content server 60 pass through the Internet 50, and are transferred to the load balancer 200 through the switch 500.

The load balancer 200 inspects header information on the received packets, selects a designated one from the virtual P-GWs 334 that relays the mobile communication, and allocates an identifier such as a VLAN tag for indicating the appropriate virtual P-GW 334 to the packet, or replaces a destination IP address of the packet. Thereafter, the load balancer 200 transfers the identifier to the bandwidth control apparatus 100.

The bandwidth control apparatus 100 buffers the packets according to a procedure to be described later, and thereafter transfers the packets toward the appropriate virtual P-GW 334 according to the designated bandwidth.

The virtual P-GW 334 encapsulates the received packets, and transmits the encapsulated packets to the switch 500. The switch 500 transfers the packets received from the virtual P-GW 334 to the load balancer 200.

The load balancer 200 inspects header information on the received packets, selects a designated one from the virtual S-GWs 333 that relays the mobile communication, and allocates an identifier such as a VLAN tag for indicating the appropriate virtual S-GW 333 to the packet, or replaces a destination IP address of the packet. Thereafter, the load balancer 200 transfers the identifier to the bandwidth control apparatus 100.

The bandwidth control apparatus 100 buffers the packets according to a procedure to be described later, and thereafter transfers the packets toward the appropriate virtual S-GW 333 according to the designated bandwidth.

The virtual S-GW 333 decapsulates the received packets, and transmits the packets to the switch 500. The switch 500 transmits the packets received from the virtual S-GW 333 to the access network 30, and the packets arrive at the mobile terminal 10 through the designated base station 20.

### Operation of Bandwidth Control Apparatus 100

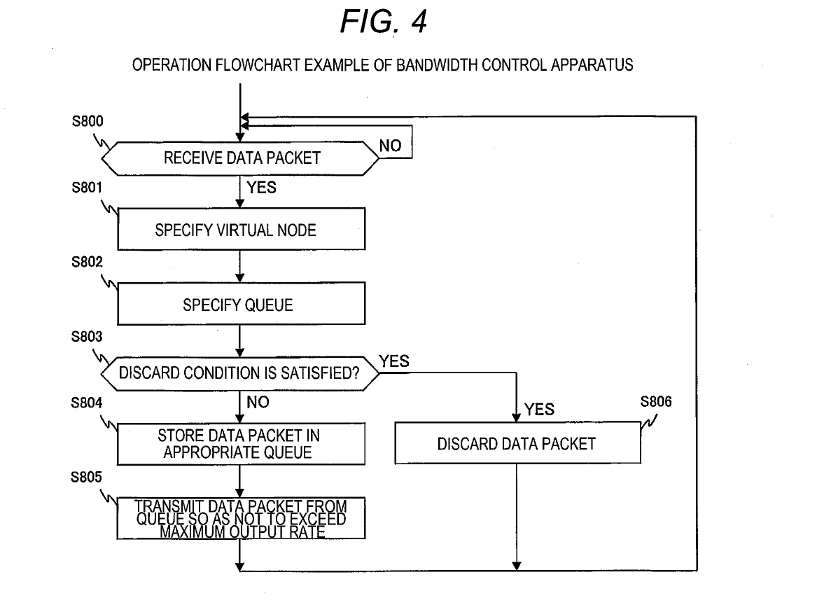

Subsequently, the operation of the bandwidth control apparatus 100 will be described with reference to the exemplary configuration of the bandwidth control apparatus 100 in FIG. 2, the exemplary configuration of the buffer management table 112 in FIG. 3, and an exemplary flowchart of the bandwidth control apparatus in FIG. 4.

Upon receiving the packets (Step S800 in FIG. 4), the bandwidth control apparatus 100 extracts information for specifying which virtual node such as the virtual S-GW 333 or the virtual P-GW 334 the packets are addressed to, information for specifying which virtual P-GW 334 the packets are addressed to among the plural virtual P-GWs 334 if the virtual node is the virtual P-GW, and information for specifying a queue No. to be held from the user to which the packets belong, or the communication type, in the packet header analysis unit 120. For convenience, the information extracted as described above is called “search key”.

For example, in order to specify that the packets are addressed to the virtual P-GW 334 in the communication (communication toward the Internet 50 from the access network 30) in the uplink direction, for example, since a GRE (generic routing encapsulation) tunnel should be established between the virtual S-GW 333 and the virtual P-GW 334, that the packets have a packet format of the GRE, a source IP address of the packets indicates the virtual S-GW 333, or the destination IP address represents the virtual P-GW 334 may be specified. Hence, those conditions (packet format, source IP address, destination IP address) are extracted as the search key.

Also, in the above case, an identifier called “GRE key” is extracted from the packet header of the GRE as the search key for specifying which virtual P-GW 334 the packets are addressed to among the plural virtual P-GWs 334. Because the GRE key can be also used for specifying the user, the GRE key is also extracted as the search key for specifying the queue No.

Upon receiving the packets and the above search key, the distribution unit 130 determines which virtual node the packets are addressed to (for example, which of the virtual P-GWs 334 the packets are addressed to) according to the same distribution logic as that in the load balancer 200 (Step S801).

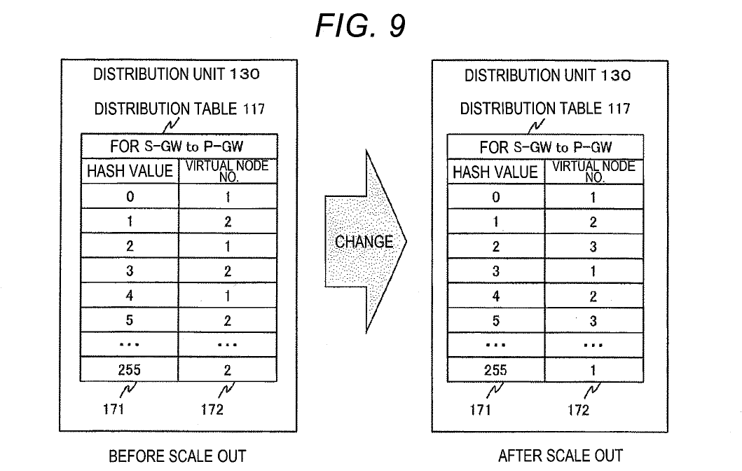

For example, if a hash function is used for the distribution logic, the hash function is applied to the search key, and No. of the obtained operation results is checked against a given table, and dealt with as the virtual node No., to thereby specify the virtual node. For example, a distribution table 117 shown on a left side of FIG. 9 is provided, and the results of the hash function are dealt with as values of a hash value field 171, and a value written in a virtual node No. field 172 corresponding to the entry is dealt with as the virtual node No.

Also, if a table using no hash function is used for the distribution logic, the table is searched with the search key as an index, and the virtual node No. described in the appropriate entry is read to specify the virtual node.

Also, in the above example, the distribution unit 130 specifies the queue No. with the GRE key as the search key (Step S802).

In all cases, if the distribution unit 130 specifies the virtual node No. and queue No. where the packet is to be processed, the distribution unit 130 confirms the remaining amount of buffer in the appropriate queue of the buffer unit for auto scaling 140, and stores the packets in the appropriate high priority queue 145 or the appropriate low priority queue 146 if a free region is present in the buffer (from Step S803 to Step S804).

If no free region is present in the buffer, or an algorithm such as a RED (random early detection) is applied to satisfy discard conditions of the packets even if the free region is present, the packets are discarded without being stored (from Step S803 to Step S806).

The virtual node bandwidth limiter 144 sets the upper limit bandwidth for each of the virtual nodes in advance, adjusts the number of transmission packets to the respective virtual nodes to the number of packets which can be processed by the virtual node while extracting the packets from the high priority queues 145 providing the guaranteed bandwidth according to a given algorithm, or from the low priority queues 146 providing no guaranteed bandwidth, and outputs the packets from the output selector 160 (Step S805).

In the preferred embodiments, in extraction of the packets, one of the plural virtual node bandwidth limiters 144 is selected in a round-robin system. Also, when the high priority queues 145 and the low priority queues 146 are provided, the respective virtual node bandwidth limiters 144 prioritize the extraction of the packets from the high priority queues 145.

As another preferred embodiment, if the packets are present in the high priority queues 145, there are applied algorithms such as strict priority that always prioritizes the extraction from the high priority queues 145, or weighted round-robin that extracts the packets from the low priority queues 146 at a given rate even if the packets are present in the high priority queues 145.

### Queue of Bandwidth Control Apparatus 100

The buffer unit for auto scaling 140 holds the plural queues as the unused queues 150 in an initial state, and allocates the unused queues 150 as the high priority queues 145 or the low priority queues 146 to the communication of the appropriate user according to an instruction from the control server 400. Also, the buffer unit for auto scaling 140 allocates the virtual node bandwidth limiter 144 to each of the appropriate virtual nodes, and associates the virtual node bandwidth limiter 144 with the appropriate high priority queues 145 and the appropriate low priority queues 146.

As another embodiment, not two-level priority queues such as the high priority queues 145 and the low priority queues 146, but priority queues of multiple levels are provided, and in each of the users, VoIP (voice over IP) and a real time image requiring a real time property are allocated to the queues high in priority, and electronic mails, files, and web browsing carried by a TCP (transmission control protocol) are allocated to the queues in low in priority. Thus, the prioritization of communication may be conducted within the user.

If the high priority and the low priority are not distinguished from each other for each of the users, the communication of the user may be allocated to one high priority queue 145 or low priority queue 146, or may be allocated to a queue having no distinction between the high priority and the low priority.

The configuration of the queues described above is of a type in which two-hierarchy shaping is conducted when the virtual node bandwidth limiter 144 is a first hierarchy, and the high priority queues 145 and the low priority queues 146 are a second hierarchy.

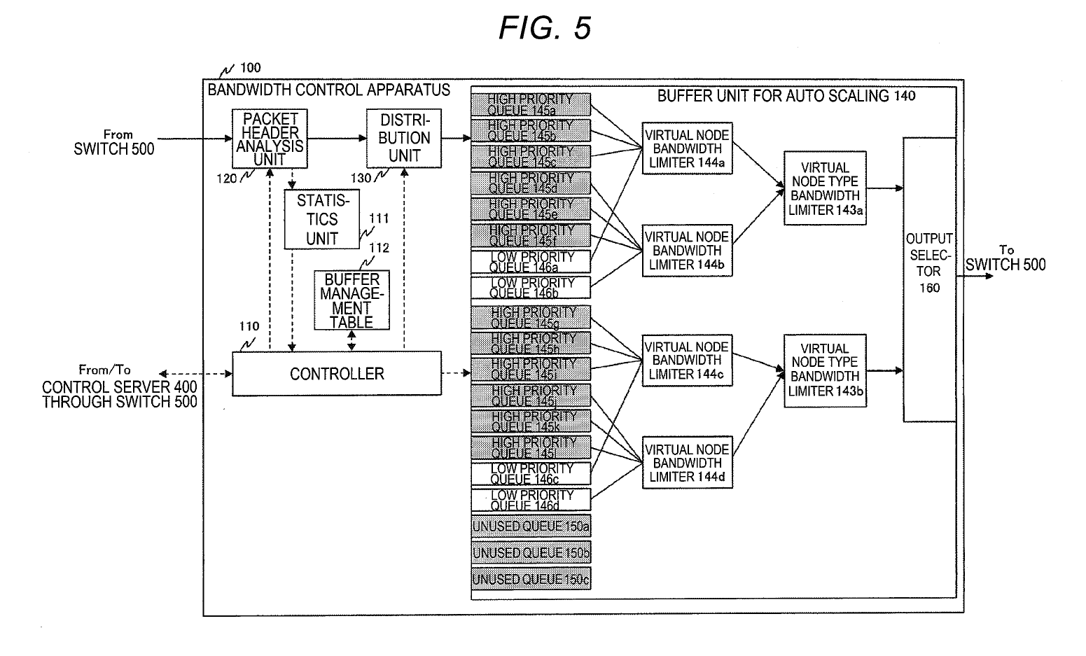

Also, when a group of one or more virtual MME 332, a group of one or more virtual S-GW 333, and a group of one or more virtual P-GW 334 are assumed, and a total value of each of the virtual node types is also subjected to bandwidth limitation, as illustrated in FIG. 5, three hierarchies are shaped with the virtual node type bandwidth limiter 143 that conducts bandwidth limitation on the first hierarchy on an virtual node type basis such as the virtual P-GW 334, a virtual node bandwidth limiter 144 that conducts the bandwidth limitation on the second hierarchy by the individual virtual node such as P-GW 334, and the third hierarchy as the high priority queues 145 and the low priority queues 146.

For example, a virtual node type bandwidth limiter 143a in FIG. 5 is allocated to the bandwidth limitation of the overall virtual P-GW 334a and virtual P-GW 334b in FIG. 1, a virtual node bandwidth limiter 144a is allocated to the bandwidth limitation of the individual virtual P-GW 334a, and a virtual node bandwidth limiter 144b is allocated to the bandwidth limitation of the virtual P-GW 334b.

Also, assuming an MVNO (mobile virtual network operator), when plural communication carriers share the system of this embodiment, one hierarchy of the bandwidth limiter for each of the carriers is added between the virtual node type bandwidth limiter 143 and the output selector 160 in FIG. 5, and four hierarchies are shaped as a whole. Alternatively, the virtual node type bandwidth limiter 143 in FIG. 5 may be dealt with as the bandwidth limiter for each of the carriers, and three hierarchies may be shaped.

In all of those cases, a minimum guaranteed bandwidth is configured in the high priority queues 145 which is the lowest hierarchy to guarantee the communication bandwidth. In all of the remaining hierarchies, an upper limit bandwidth is configured to guarantee that communication equal to or higher than a designated bandwidth does not flow into the system and the virtual node of the appropriate carrier.

A total value of the guaranteed bandwidths of the high priority queues 145 needs to be set to a value which does not exceed the upper limit bandwidths of the virtual node bandwidth limiter 144 and the virtual node type bandwidth limiter 143.

### Operation of Scale-Out

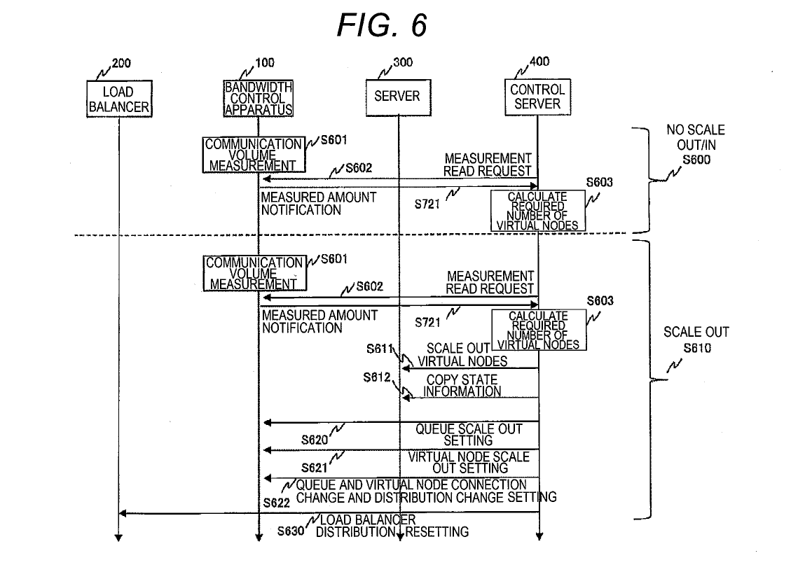

Subsequently, a description will be given of the operation of scale out or in (scaling) the virtual nodes such as the virtual P-GW 334 in this embodiment with reference to FIG. 6. The bandwidth control apparatus 100 always measures a total number (the number of packets and the number of bits per given time such as per second) of packets received by the bandwidth control apparatus 100, which are transmitted toward the subject apparatus for each type of the virtual nodes such as the virtual P-GW 334 or the virtual S-GW 333, and a total number (the number of packets and the number of bits per given time such as per second) of packets received by the bandwidth control apparatus 100, which are addressed to the individual virtual node (Step S601). Those measurement results are preferable to determine the scale out or in of the virtual nodes that conduct data transfer processing such as the virtual P-GW 334 or the virtual S-GW 333.

Also, in order to determine the scale out or in of the virtual nodes that conduct the connection processing such as the virtual MME 332, when the mobile terminal 10 is connected to the mobile communication network, plural exchanges of packets are conducted between the mobile terminal 10 and the virtual MME 332. For that reason, the bandwidth control apparatus 100 preferably extracts only packets indicative of a first connection request from the mobile terminal 10 from the packets addressed to the virtual MME 332, and measures a total number (the number of packets per second) of packets in use.

The control server 400 periodically notifies the bandwidth control apparatus 100 of a measurement read request at timing designated in advance such as every three seconds, every ten seconds, or every one minute (Step S602). In response to the notification, the bandwidth control apparatus 100 performs a measured amount notification (Step S721). The control server 400 may designate the timing at which the measurement result to be periodically notified in advance, and the bandwidth control apparatus 100 may actively notify the control server 400 of the measurement result. Also, the bandwidth control apparatus 100 may notify the control server 400 of the measurement result at a relatively long time frequency such as every one minute or every ten minutes until a condition (a rapid increase or a rapid decrease in traffic, etc.) designated by the control server 400 is satisfied. If the condition is satisfied, the bandwidth control apparatus 100 may notify the control server 400 of the measurement result at a relatively short time frequency such as every three seconds or every ten seconds.

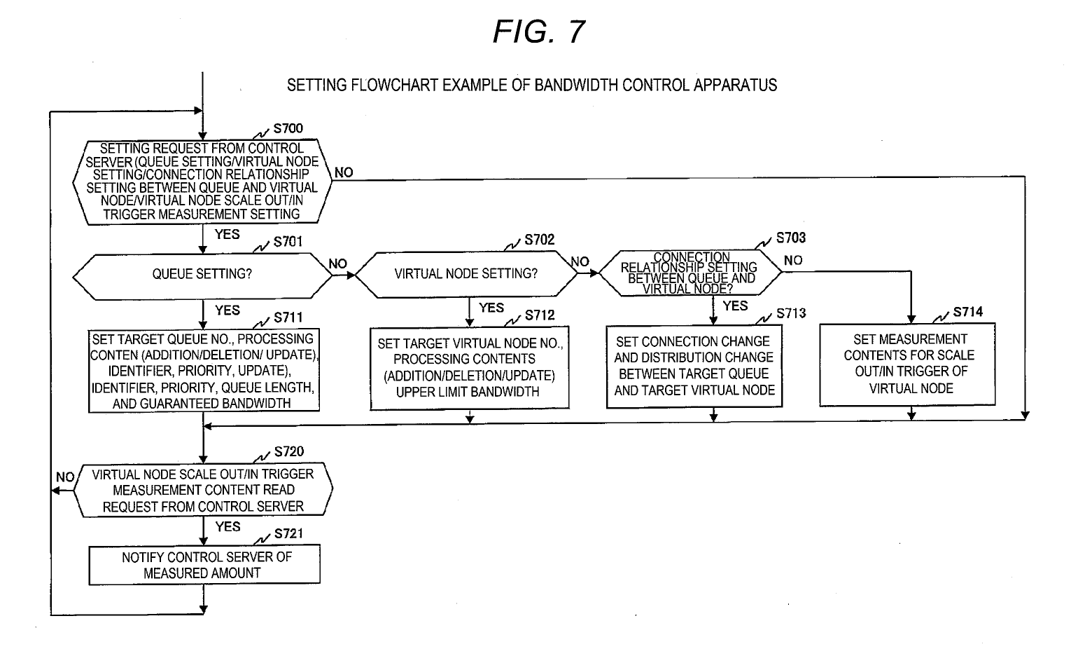

When viewed from a viewpoint of the bandwidth control apparatus 100, in a flowchart of FIG. 7, the flow transitions in the stated order of Step S700, Step S720, and Step S721, and the measurement result measured in the statistics unit 111 is notified the control server 400. In setting the measurement contents to be notified, in the flowchart of FIG. 7, the flow transitions in the stated order of Step S700, Step S701, Step S702, Step S703, and Step S714, and the control server 400 receives information on the measurement contents for scale out or in trigger of the virtual nodes, and sets the measurement contents for the statistics unit 111 through the controller 110.

Upon receiving the measured amount notification, the control server 400 determines whether the scale-out condition to exceed a given threshold value is satisfied, or not, taking a past measurement history and the latest measurement history for each kind of the virtual nodes such as the virtual S-GW 333 or the virtual P-GW 334 in account. That is, the control server 400 calculates the required number of virtual nodes (Step S603 in FIG. 6). If the scale-out condition is not satisfied, the control server 400 maintains the configuration of the system as it is (corresponding to a flowchart having no scale out or in in S600 of FIG. 6). If the scale-out condition is satisfied, the control server 400 implements the scale-out of the appropriate virtual node (corresponding to a flowchart having the scale-out in 5610 of FIG. 6).

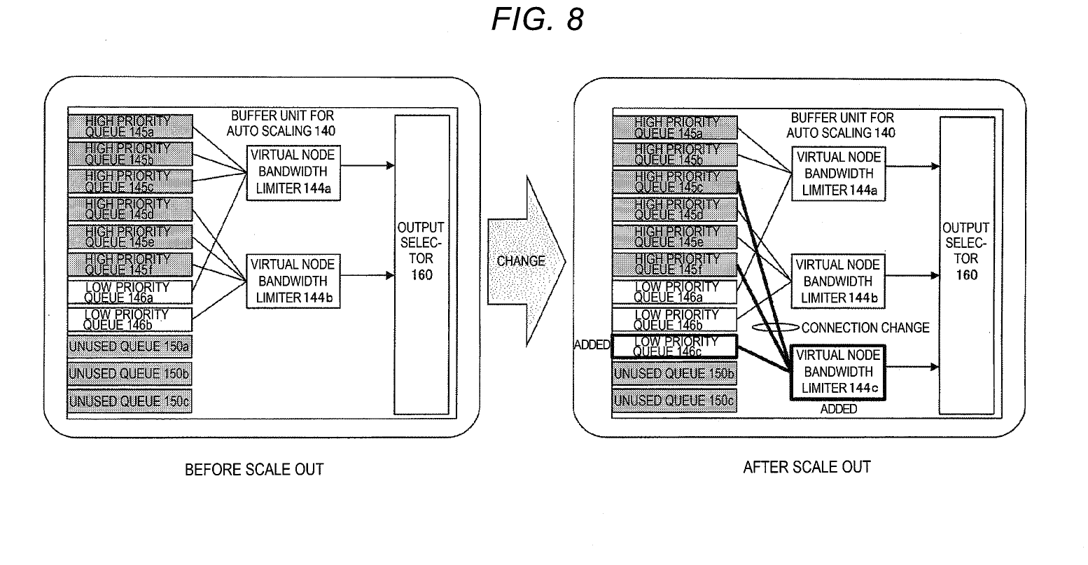

In this example, the operation when the scale-out condition of the virtual P-GW 334 is satisfied will be described with reference to flowcharts of FIGS. 6 and 7, an illustrative view of a change in the buffer unit for auto scaling 140 within the bandwidth control apparatus 100 illustrated in FIG. 8, and an illustrative view of a change in a distribution table 117 illustrated in FIG. 9. In this example, a description will be given of a case in which an event such as the Internet live occurs, the users start video viewing simultaneously, and the traffic volume per user increases, without increasing the number of users having a contract for high priority communication.

In this example, a case in which one virtual P-GW 334 is scaled out will be described. However, the present invention is compatible with a case in which two or more virtual P-GWs 334 are scaled out by following the following description. If the scale-out condition of the virtual P-GW 334 is satisfied, the control server 400 instructs the server 300 to prepare the virtual machines 330 by the number of the virtual P-GWs 334 increased for the server 300, and to start the virtual P-GW 334 program on the virtual machines 330 (Step S611 in FIG. 6). Also, the control server 400 copies state information on a moving communication session from the virtual P-GWs 334a and 334b that have already been operating, for the started virtual P-GW 334c (Step S612 in FIG. 6).

When the appropriate virtual node (virtual P-GW 334) starts, the control server 400 notifies the bandwidth control apparatus 100 of queue scale-out setting by the number of scaled-out virtual nodes (virtual P-GW 334) (Step S620 in FIG. 6). In this example, as illustrated in FIG. 8, the control server 400 adds one low priority queue 146c for the added virtual P-GW 334, without adding the high priority queues 145.

When viewed from a viewpoint of the bandwidth control apparatus 100, in a flowchart of FIG. 7, the flow transitions in the stated order of Step S700, Step S701, and Step S711, and No. of the target queue, the processing contents (addition/deletion/update), the identifier, the priority, the queue length, and the guaranteed bandwidth are set. In an example of FIG. 8, the controller 110 of the bandwidth control apparatus 100 receives from the control server 400, information on No. of the added queue, “addition” as the processing contents, “communication identifier (information indicative of the virtual S-GW 333 to the virtual P-GW 334)” as the identifier, “low priority” as the priority, and, for example, “8 Kbyte” as the queue length, and records those information in the queue management table 119 of the buffer management table 112. Then, the controller 110 sets the contents of the queue management table 119 for the buffer unit for auto scaling 140. Because the setting contents are only the low priority queues, the set value of the guaranteed bandwidth does not accept a valid value.

Then, the control server 400 notifies the bandwidth control apparatus 100 of the virtual node scale-out setting by the number of scaled-out virtual nodes (virtual P-GW 334) (Step S621 in FIG. 6). In this example, as illustrated in FIG. 8, a virtual node bandwidth limiter 144c is added.

When viewed from a viewpoint of the bandwidth control apparatus 100, in the flowchart of FIG. 7, the flow transitions in the stated order of Step S700, Step S701, Step S702, and Step S712, and No. of the target virtual node, the processing contents (addition/deletion/update), and the upper limit bandwidth are set. In an example of FIG. 8, the controller 110 of the bandwidth control apparatus 100 receives from the control server 400, information on No. of the added virtual node, “addition” as the processing contents, and for example, “1000 Mbps” as the upper limit bandwidth, and records those information in the virtual node management table 118 of the buffer management table 112. Then, the controller 110 sets the contents of the virtual node management table 118 for the buffer unit for auto scaling 140.

Then, the control server 400 notifies the bandwidth control apparatus 100 of the connection change (association change) of the queues and the virtual nodes (virtual P-GW 334), and the setting of the distribution change (Step S622 in FIG. 6). In this example, as illustrated in FIG. 8, the high priority queue 145c and the high priority queue 145f are changed to be connected to the virtual node bandwidth limiter 144c, and also the low priority queue 146c is also connected to the virtual node bandwidth limiter 144c (that is, an association of the high priority queue and the low priority queue to the virtual node bandwidth limiter is changed). Also, the entry contents of the distribution table for distribution are changed to realize distribution compatible to the scale-out.

When viewed from a viewpoint of the bandwidth control apparatus 100, in the flowchart of FIG. 7, the flow transitions in the stated order of Step S700, Step S701, Step S702, Step S703, and Step S713, and the connection change (association change) and the distribution change of the target queues and the target virtual nodes are set. In an example of FIG. 8, the controller 110 of the bandwidth control apparatus 100 receives, as information of “connection change of the target queues and the target virtual nodes”, removal of the high priority queue 145c from the virtual node bandwidth limiter 144a of the virtual node 1 (virtual P-GW 334a), and the high priority queue 145f from the virtual node bandwidth limiter 144b of the virtual node (virtual P-GW 334b), from the control server 400, as the connection change. The controller 110 of the bandwidth control apparatus 100 also receives, as information of “connection change of the target queues and the target virtual nodes”, connection of the high priority queue 145c and the high priority queue 145f to the virtual node bandwidth limiter 144c of the virtual node 3 (virtual P-GW 334c). Also, the controller 110 of the bandwidth control apparatus 100 receives, as information of “connection change of the target queues and the target virtual nodes”, connection of the low priority queue 146c to the virtual node bandwidth limiter 144c, and records those information in the connection queue field 183 of the virtual node management table 118 in the buffer management table 112. Then, the controller 110 sets the contents of the virtual node management table 118 for the buffer unit for auto scaling 140.

The above description referring to FIG. 8 is given of the operation when one low priority queue 146c for the added virtual P-GW 334 is added without adding the high priority queue 145. In adding the virtual node bandwidth limiter 144c, the high priority queue 145 is also newly added, and the communication sessions of the high priority queues 145c and 145f connected to the virtual node bandwidth limiters 144a and 144b, and dealt with up to then may be dealt with by the high priority queue 145 newly added for the virtual node bandwidth limiter 144c. In this case, an entry of the appropriate queue No. in the queue management table 119 may be deleted once, or dealt with as an invalid state, and entry information of the high priority queue newly added may be added.

Also, as the distribution change, as illustrated in change diagrams before and after the scale out or in of a distribution table 117 in FIG. 9, when a hash function is used for distribution, a value of the virtual node No. field 172 to a hash value field 171 is 1 (corresponding to the virtual P-GW 334a) and 2 (corresponding to the virtual P-GW 334b) before scale-out, but updated to be added with 3 (corresponding to virtual P-GW 334c) to 1 and 2 after scale-out.

Under the above control, when the setting change of the bandwidth control apparatus 100 has been finished, the control server 400 notifies the load balancer 200 of resetting of the distribution information (Step S630 in FIG. 6). Specifically, the same processing as that of the setting change in the distribution table 117 in FIG. 9 described in the distribution change of the bandwidth control apparatus 100 is implemented on the load balancer 200.

Upon completion of all of the above setting, the scale-out of the virtual P-GW 334 is completed, and thereafter the relay processing of the mobile communication using the three virtual P-GWs 334 scaled out from two virtual P-GWs 334 is conducted through the load balancer 200 and the bandwidth control apparatus 100.

In this example, a description is given of a case in which an event such as the Internet live occurs, the users start video viewing simultaneously, and the traffic volume per user increases, without increasing the number of users having a contract for high priority communication. A case in which the number of users rapidly increases, and a total traffic volume increases, and a case in which both of those cases are mixed together are also present. Those cases are different from the above-mentioned case in that the high priority queue 145 is newly added, and the remaining processing may be conducted in the same manner as that described above.

### Operation of Scale-in

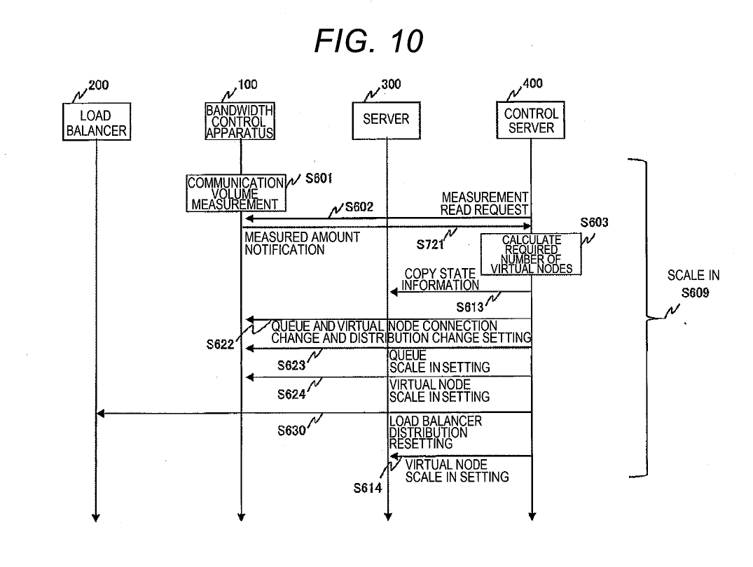

Then, the operation when the scale-in condition of the virtual P-GW 334 is satisfied will be described with reference to flowcharts of FIGS. 10 and 7, an illustrative view of a change of the buffer unit for auto scaling 140 within the bandwidth control apparatus 100 illustrated in FIG. 8, and an illustrative view of a change in a distribution table 117 illustrated in FIG. 9.

In this example, a description will be given of a case in which an event such as the Internet live is finished, the users finish video viewing simultaneously, and the traffic volume per user decreases, without increasing the number of users having the contract for high priority communication.

The control server 400 periodically notifies the bandwidth control apparatus 100 of a measurement read request at timing designated in advance such as every three seconds, every ten seconds, or every one minute (Step S602 in FIG. 10). In response to the notification, the bandwidth control apparatus 100 performs a measured amount notification (Step S721 in FIG. 10).

Upon receiving the measured amount notification, the control server 400 determines whether a scale-in condition such that the measured amount falls below a given threshold value is satisfied, or not, taking a past measurement history and the updated measurement history for each of the types of virtual nodes such as the virtual S-GW 333 or the virtual P-GW 334 into account. That is, the control server 400 calculates the required number of virtual nodes (Step S603 in FIG. 10). If the scale-in condition is satisfied, the control server 400 implements the scale-in of the appropriate virtual nodes (corresponding to a flowchart in the presence of scale-in in S609 of FIG. 10).

In this example, a description will be given of a case in which one virtual P-GW 334 is scaled in. This example is also compatible with a case in which two or more virtual P-GWs 334 are scaled in by following the following description.

The control server 400 copies state information on a moving communication session moving with respect to the virtual P-GWs 334a and 334b maintaining their presence from the scale-in virtual P-GW 334c, for the server 300 (Step S613 in FIG. 10).

Then, the control server 400 notifies the bandwidth control apparatus 100 of the setting of a connection change (association change) and the distribution change of the queue and the virtual node (virtual P-GW 334) (Step S622 in FIG. 10). This example corresponds to an example opposite to that in FIG. 8, that is, an example in which a state returns to before scale-out from after scale-out. For that reason, the high priority queue 145c is changed to be connected to the virtual node bandwidth limiter 144a, and the high priority queue 145f is changed to be connected to the virtual node bandwidth limiter 144b, and a connection between the low priority queue 146c and the virtual node bandwidth limiter 144c is canceled (that is, an association of the high priority queues and the low priority queues with the virtual node bandwidth limiters is changed). Also, the entry contents of the distribution table for distribution are changed to realize the distribution corresponding to the scale-in.

When viewed from a viewpoint of the bandwidth control apparatus 100, in the flowchart of FIG. 7, the flow transitions in the stated order of Step S700, Step S701, Step S702, Step S703, and Step S713, and the connection change (association change) and the distribution change of the target queues and the target virtual nodes are set. In this example, the controller 110 of the bandwidth control apparatus 100 receives, as the connection change, information on the above-mentioned connection change from the control server 400 as information of “connection change of the target queues and the target virtual nodes”, and records the information in the connection queue field 183 of the virtual node management table 118 in the buffer management table 112. Then, the controller 110 sets the contents of the virtual node management table 118 for the buffer unit for auto scaling 140.

The above description referring to FIG. 8 is given of the operation when the connection of the high priority queue 145c and the high priority queue 145f is changed. Alternatively, the high priority queue 145 dealt with as addition in the virtual node bandwidth limiters 144a and 144b may be newly added to the queue management table 119, or invalidated queue may be again validated, and connected to the virtual node bandwidth limiters 144a and 144b in use.

Also, in this case, the distribution change corresponds to an example opposite to that of the change diagrams before and after the scale-out and scale-in of the distribution table 117 in FIG. 9, that is, corresponds to an example in which the distribution returns to before scale-out from after scale-out. If the hash function is used for distribution, a value of the virtual node No. field 172 to the hash value field 171 is 1 (corresponding to virtual P-GW 334a), 2 (corresponding to virtual P-GW 334b), and 3 (corresponding to virtual P-GW 334c) before scale-out, but is updated to only 1 and 2 after scale-in.

Then, the control server 400 notifies the bandwidth control apparatus 100 of the queue scale-in setting for the scaled-in virtual node (virtual P-GW 334c) (Step S623 in FIG. 10). In this example, as illustrated in FIG. 8, the control server 400 deletes one low priority queue 146c for the scaled-in virtual P-GW 334c.

When viewed from a viewpoint of the bandwidth control apparatus 100, in the flowchart of FIG. 7, the flow transitions in the stated order of Step S700, Step S701, and Step S711, and No. of the target queue, the processing contents (addition/deletion/update), the identifier, the priority, the queue length, and the guaranteed bandwidth are set. In the example opposite to that in FIG. 8, the controller 110 of the bandwidth control apparatus 100 receives from the control server 400, information on No. of the queue to be removed, “deletion” as the processing contents, and “communication identifier (information indicative of virtual S-GW 333 to virtual P-GW 334)” as the identifier, and records those information in the queue management table 119 of the buffer management table 112. Then, the controller 110 sets the contents of the queue management table 119 for the buffer unit for auto scaling 140. Because the setting contents are “deletion”, the set values of the priority, the queue length, and the guaranteed bandwidth do not accept valid values.

Then, the control server 400 notifies the bandwidth control apparatus 100 of the virtual node scale-in setting for the scaled-in virtual node (virtual P-GW 334c) (Step S624 in FIG. 10). In this example, as illustrated as the example opposite to that in FIG. 8, the control server 400 deletes the virtual node bandwidth limiter 144c.

When viewed from a viewpoint of the bandwidth control apparatus 100, in the flowchart of FIG. 7, the flow transitions in the stated order of Step S700, Step S701, Step S702, and Step S712, and No. of the target virtual node, the processing contents (addition/deletion/update), and the upper limit bandwidth are set. In the example opposite to that in FIG. 8, the controller 110 of the bandwidth control apparatus 100 receives from the control server 400, information on No. of the virtual node to be removed, and “deletion” as the processing contents and records those information in the virtual node management table 118 of the buffer management table 112. Then, the controller 110 sets the contents of the virtual node management table 118 for the buffer unit for auto scaling 140. Because the setting contents are “deletion”, the set values of the upper limit bandwidth do not accept valid values.

Under the above control, when the setting change of the bandwidth control apparatus 100 has been finished, the control server 400 notifies the load balancer 200 of resetting of the distribution information (Step S630 in FIG. 10). Specifically, the same processing as the change opposite to the setting change in the distribution table 117 in FIG. 9 described in the distribution change of the bandwidth control apparatus 100 is implemented on the load balancer 200.

With the above processing, because the packets do not arrive at the virtual P-GW 334c which is the scale-in virtual node, the control server 400 conducts the scale-in setting of the appropriate virtual node on the server 300, and deletes the virtual P-GW 334c (Step S614 in FIG. 10).

Upon completion of all of the above setting, the scale-in of the virtual P-GW 334c is completed, and thereafter the relay processing of the mobile communication using the two virtual P-GWs 334 scaled in from three virtual P-GWs 334 is conducted through the load balancer 200 and the bandwidth control apparatus 100.

In this example, a description is given of a case in which an event such as the Internet live is finished, the users finish video viewing simultaneously, and the traffic volume per user decreases, without increasing the number of users having a contract for high priority communication. A case in which the number of users rapidly decreases, and a total traffic volume decreases, and a case in which both of those cases are mixed together are also present. In those cases, the same processing at that described above may be conducted.

Reasons Why System can be Protected in this Embodiment

According to this embodiment described above, with the introduction of the virtual node bandwidth limiter 144 and the virtual node type bandwidth limiter 143 provided in the buffer unit for auto scaling 140 of the bandwidth control apparatus 100, because an excessive communication does not flow in the virtual nodes such as the virtual S-GW 333 or the virtual P-GW 334 even in both of the normal state, and the ongoing scale-out state, the system protection can be conducted.

Reasons Why Communication of High Priority User can be Protected in this Embodiment

Also, according to this embodiment, with the introduction of the high priority queues 145 into the buffer unit for auto scaling 140 of the bandwidth control apparatus 100, in the communication of the user who desires high quality communication even paying an additional fee, the packet loss can be avoided even in the overload status, and high-quality communication can be continuously provided.

Reasons Why System Protection is enabled even if Scale Out or In is Repeated in this Embodiment

Also, according to this embodiment, the scale-out and the scale-in of the virtual nodes such as the virtual P-GW 334 are controlled with the use of the buffer management table 112 of the buffer unit for auto scaling 140 in the bandwidth control apparatus 100, and the connection relationship between the high priority queues 145, the low priority queues 146, and the virtual node bandwidth limiter 144 is updated under the control. As a result, the high-quality communication can be continuously provided to the priority user without incurring the system down even if the scale-out and scale-in of the virtual nodes are repeated.

What is claimed is:

1. A bandwidth control apparatus that transmits packets to a plurality of virtual nodes equipped in a server device, the apparatus comprising:
a controller that controls the bandwidth control apparatus; and
a buffer unit that controls queues which hold the packets,
wherein the buffer unit includes:
a plurality of high priority queues that holds the packets of high priority, and guarantees a packet transmission amount in a given guaranteed bandwidth;
a plurality of low priority queues that holds packets of low priority; and
a virtual node bandwidth limiter that is disposed for each of the virtual nodes, reads the packets from any high priority queue and any low priority queue which are associated with the virtual node bandwidth limiter, and limits the packets to an upper limit bandwidth determined for each of the virtual nodes,
wherein the buffer unit changes association of the high priority queues and the low priority queues with the virtual node bandwidth limiter according to an instruction from the controller that is instructed from a control server that determines scale out or in of the virtual nodes.

2. The bandwidth control apparatus according to claim 1,
wherein if the control server determines that the virtual node is scaled out, according to the instruction from the controller,
the buffer unit adds a new virtual node bandwidth limiter for the scaled-out virtual node and a new low priority queue in association with each other, and changes the high priority queues associated with the other virtual node bandwidth limiter to be associated with the new virtual node bandwidth limiter, and
the new virtual node bandwidth limiter reads the packets from the high priority queue associated with the new virtual node bandwidth limiter and the new low priority queue, and limits the packets to the upper limit bandwidth determined for the. scaled-out virtual node.

3. The bandwidth control apparatus according to claim 1,
wherein if the control server determines that the virtual node is scaled out, according to the instruction from the controller,
the buffer unit adds a new virtual node bandwidth limiter for the scaled-out virtual node, a new high priority queue, and a new low priority queue in association with each other, and deletes or disables the high priority queues associated with the other virtual node bandwidth limiter, and
the new virtual node bandwidth limiter reads the packets from the new high priority queue and the new low priority queues, and limits the packets to the upper limit bandwidth determined for the scaled-out virtual node.

4. The bandwidth control apparatus according to claim 1,
wherein if the control server determines that the virtual node is scaled in, according to an instruction from the controller,
the buffer unit changes the high priority queue associated with the virtual node bandwidth limiter for the scaled-in virtual node to be associated with another virtual node bandwidth limiter, deletes the low priority queue associated with the virtual node bandwidth limiter for the scaled-in virtual node, and deletes the virtual node bandwidth limiter for the scaled-in virtual node.

5. The bandwidth control apparatus according to claim 1,
wherein if the control server determines that the virtual node is scaled in, according to an instruction from the controller,
the buffer unit deletes the high priority queue and the low priority queue which are associated with the virtual node bandwidth limiter for the scaled-in virtual nodes, deletes the virtual node bandwidth limiter for the scaled-in virtual node, creates a new high priority queue corresponding to the high priority queue associated with the virtual node bandwidth limiter for the scaled-in virtual node, and associates the new high priority queue with the virtual node bandwidth limiter for the remaining virtual node.

6. The bandwidth control apparatus according to claim 1, further comprising:
a statistics unit that measures a given amount of communication packets; and
a buffer management table for managing the buffer unit,
wherein the controller transmits measurement results measured by the statistics unit to the control server,
receives, as the instructions from the control server, setting information on the high priority queues and the low priority queues, setting information on the virtual node bandwidth limiters, setting information for determining association between the high priority queues and the low priority queues, and the virtual node bandwidth limiter, and records those setting information in the butter management table, and
instructs the buffer unit to change the association on the basis of the setting contents recorded in the buffer management table.

7. The bandwidth control apparatus according to claim 6,
wherein, if there is a request for reading the measurement results from the control server, or if a preset time comes, the controller transmits the measurement results to the control server.

8. The bandwidth control apparatus according to claim 6,
wherein the butter management table manages
virtual node numbers for identifying the virtual nodes,
upper limit bandwidths determined for the respective virtual nodes,
association queue information for identifying queues associated with the virtual node bandwidth limiter,
allocation statuses for identifying whether the queues provided in the buffer unit are allocated as the high priority queues or the low priority queues, or not,
queue numbers for identifying the queues provided in the buffer unit,
communication identifiers for identifying communication of the packets stored in the queues,
user identifiers for identifying the users of the packets stored in the queues,
priorities indicating whether each of the queues is dealt with as any one of the high priority queues and the low priority queues,
guaranteed bandwidths for guaranteeing a packet transmission amount in the high priority queues, and
queue lengths of the high priority queues or the low priority queues.

9. The bandwidth control apparatus according to claim 6,
wherein if the virtual node is a communication node for conducting data transfer processing, the statistics unit sets the number of packets per given time which are received by the bandwidth control apparatus, or the number of bits measured for each of the virtual nodes as the given amount of communication packets, and
if the virtual nodes are communication nodes for conducting connection processing,
the statistics unit sets the number of packets indicating a first connection request per given time, and received by the bandwidth control apparatus, which is measured for each of the virtual nodes as the given amount of communication packets.

10. The bandwidth control apparatus according to claim 1,
wherein the upper limit bandwidth and the guaranteed bandwidth are determined according to the number of packets or the number of bits per given time if the virtual nodes are communication nodes for conducting the data transfer processing, and
the upper limit bandwidth and the guaranteed bandwidth are determined according to the number of packets indicating a first connection request per given time if the virtual nodes are communication nodes for conducting the connection processing.

11. The bandwidth control apparatus according claim 1,
wherein the upper limit bandwidth is periodically updated from the control server.

12. The bandwidth control apparatus according claim 1,
wherein the virtual node bandwidth limiter conducts upper limit bandwidth control using the upper limit bandwidth as the bandwidth control of a first hierarchy, and
the high priority queue conducts guaranteed bandwidth control using the guaranteed bandwidth as the bandwidth control of a second hierarchy.

13. The bandwidth control apparatus according to claim 1,
wherein the buffer unit further includes a virtual node type bandwidth limiter that conducts the bandwidth control for each of the virtual node types,
the virtual node type bandwidth limiter conducts upper limit bandwidth control using a second upper limit bandwidth determined for each of the virtual node types as the bandwidth control of a first hierarchy,
each of the virtual node bandwidth limiters conducts upper limit bandwidth control using the upper limit bandwidth as the bandwidth control of a second hierarchy, and
the high priority queue conducts the guaranteed bandwidth control using the guaranteed bandwidth as the bandwidth control of a third hierarchy.

14. The bandwidth control apparatus according to claim 1,
wherein the buffer unit further includes a communication carrier bandwidth limiter that conducts the bandwidth control for each of communication carriers,
the communication carrier bandwidth limiter conducts the upper limit bandwidth control using a third upper limit bandwidth determined for each of the communication carriers as the bandwidth control of a first hierarchy,
each of the virtual node bandwidth limiters conducts the upper limit bandwidth control using the upper limit bandwidth as the bandwidth control of a second hierarchy, and
the high priority queue conducts the guaranteed bandwidth control using the guaranteed bandwidth as the bandwidth control of a third hierarchy.

15. The bandwidth control apparatus according to claim 1, further comprising:
a header analysis unit that analyzes a header of each received packet, and specifies virtual node information to be processed and queue information holding the packets; and
a distribution unit that distributes the packets to the high priority queues and the low priority queues on the basis of the virtual node information and the queue information,
wherein the distribution unit uses the same distribution algorithm as that of a load balancer that is connected to the server device through a network to distribute a mobile communication to appropriate virtual nodes.

16. The bandwidth control apparatus according to claim 1,
wherein the bandwidth control apparatus is configured by a dedicated hardware.

17. The bandwidth control apparatus according claim 1,
wherein the bandwidth control apparatus is configured by a virtual machine of the server device.
